(19) United States
(12) Patent Application Publication
(10) Pub. No.: US 2025/0344716 A1
(43) Pub. Date: Nov. 13, 2025

(54) CONFECTIONERY COMPOSITION WITH HIGH FIBRE

(71) Applicant: Kraft Foods Schweiz Holding GmbH, Zug (CH)

(72) Inventors: Teresa Ennis, Birmingham (GB); Clive Norton, East Hanover, NJ (US); Adam Harris, Birmingham (GB); Sonia Miguel, Reading (GB)

(21) Appl. No.: 18/866,042

(22) PCT Filed: May 30, 2023
(86) PCT No.: PCT/EP2023/025256

§ 371 Date: Nov. 14, 2024

Related U.S. Application Data
(60) Provisional application No. 63/347,536, filed on May 31, 2022.

(30) Foreign Application Priority Data
Jun. 10, 2022 (GB) 2208503.9

(51) Int. Cl. A23G 3/42; A23G 1/40; A23G 3/38; A23G 3/54

(52) U.S. Cl. CPC A23G 3/42; A23G 1/40; A23G 3/38; A23G 3/54

(57) ABSTRACT

The invention provides a confectionery composition comprising: a) at least one fructan; b) at least one isomaltose oligosaccharide (IMO); and c) at least one further soluble dietary fibre ingredient.

### TECHNICAL FIELD OF THE INVENTION

The present invention relates to a confectionery composition and a confectionery product comprising a confectionery composition. In particular, the invention relates to a confectionery composition comprising at least one fructan, at least one isomaltose oligosaccharide and at least one further soluble dietary fibre.

### BACKGROUND TO THE INVENTION

Many confectionery products on the market are considered energy dense foods; driven largely by sugar and fat-based ingredients necessary for the characteristic structure, taste, colour and texture.

There has been significant attention to sugar and higher energy dense foods in recent years and opportunities exist to develop lower sugar and/or energy confectionery products such as nougat, marshmallow, jellies, honeycomb, etc. and chocolate products.

However, “natural” sugars (such as sucrose) are a key component in many confectionery products and provide the familiar and appealing sweetness that consumers expect from such confectionery products, together with being necessary to provide an appropriate texture and structure. Many previous attempts by confectionery manufacturers to reduce or replace sugars, in particular sucrose, in confectionery products have been unsuccessful, providing an inferior taste and/or texture compared to sucrose-based and/or glucose-based (“full sugar”) products. Therefore, low sugar products must take into account consumer acceptance and satisfaction of texture, taste, structure and flavour.

One approach to reducing or replacing sugar in confectionery products has been to use a sugar alcohol (also known as “polyols”) instead of part or all of the sucrose and/or glucose. Sugar alcohols are less sweet than sucrose and/or glucose but generally provide fewer calories because they are incompletely digestible. As with many other incompletely digestible substances, overconsumption of sugar alcohols can lead to mild gastro-intestinal effects such as bloating, diarrhoea and flatulence. Many sugar alcohols may therefore have a recommended upper limit for daily consumption which may be exceeded by consuming excess amounts of such reduced sugar confectionery products. Another factor to consider is that some consumers may have a negative bias regarding products which are labelled as containing such “artificial sweeteners”.

However, although it has been known to reduce sugars in confectionery products, there is still difficulty in replacing sugars in sugar confectionery such as caramel, honeycomb, jelly, nougat, fudge and marshmallow. For example, although confectionery that contains no sugars can taste similar to sugar containing confectionery they still do not function as well in manufacturing and do not provide the same texture, mouthfeel and function as the “full sugar” sucrose-based and/or glucose-based confectionery. Moreover, the primary reason for the consumption of confectionery products is pleasure. Therefore, it is critical that the consumption experience is not compromised by a confectionery product having a reduced texture and/or taste.

Accordingly, it is an aim of the present invention to provide a confectionery composition having a reduced amount of sugars and/or calories compared to a standard confectionery composition.

It is also an aim of the present invention to provide a confectionery composition which tastes similar and has a similar texture, mouthfeel and/or function to a “full sugar” standard confectionery or confectionery filling and/or to provide a confectionery composition which provides the same texture, mouthfeel and/or function as a “full sugar” confectionery composition.

It is also an aim of the present invention to provide a confectionery product containing a confectionery composition which comprises a reduced amount of sugars and/or calories than a standard confectionery product.

It is a further aim of the present invention to provide a confectionery product having a confectionery composition which tastes similar to a confectionery product comprising a “full sugar” confectionery composition and/or to provide a confectionery product containing a confectionery composition which provides the same texture and/or function as a confectionery product comprising a “full sugar” confectionery composition.

It is also an aim of the present invention to provide a confectionery composition and/or confectionery product that addresses at least one disadvantage of the prior art or to provide an alternative to existing confectionery compositions and/or confectionery products.

### SUMMARY OF THE INVENTION

According to a first aspect of the present invention, there is provided a confectionery composition comprising:
a) at least one fructan;
b) at least one isomaltose oligosaccharide (IMO); and
c) at least one further soluble dietary fibre.

The inventors discovered that a confectionery composition comprising at least one fructan; at least one isomaltose oligosaccharide; and at least one further soluble dietary fibre ingredient was able to provide a confectionery composition with a significantly reduced amount of sugars and calories whilst still providing an acceptable taste, texture, mouthfeel and function as a “full sugar” or sucrose-based and/or glucose-based standard confectionery composition. The compositions of the invention also do not suffer significantly from the disadvantages present in some known low or no sucrose and/or glucose based confectionery compositions containing different blends of fibres or bulking agents (in particular large quantities of polydextrose, dextrin or the like). Moreover, the compositions are able to advantageously increase daily intake of dietary fibre by the consumer.

By the term “fructan” it is meant a polymer of fructose molecules having one or more fructosyl residues linked by β-2,1-linkages and/or β-2,6-linkages, and having a terminal sugar moiety (such as glucose).

The at least one fructan may be selected from the group consisting of inulin, fructooligosaccharide (FOS), levan, phlein, graminin, neo-levan, neo-inulin and combinations thereof. Preferred fructans are inulin and FOS.

By “soluble dietary fibre” it is meant a plant-based or plant-derived carbohydrate, animal-based or animal derived fibre such as milk fibres, oligosaccharides, or similar synthetic carbohydrate such as polydextrose, that is not digested in the small intestine and is soluble in water. Soluble dietary fibres are differentiated from insoluble dietary fibres which are not soluble in water, are generally metabolically inert and provide bulking in the intestinal tract. The amount of soluble dietary fibre can be measured by Official method of analysis, AOAC INTERNATIONAL. Methods 2009.

The at least one further soluble dietary fibre may comprise at least one dietary fibre selected from the group consisting of polydextrose, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, milk oligosaccharides, 2′-fucosyl lactose, lacto-n-neotetraose, glucan (i.e., glucose containing) oligosaccharides, cello-oligosaccharides (or cellodextrins), resistant dextrins (e.g., soluble corn fiber, soluble wheat fiber, soluble tapioca fiber, soluble pea fibre), nigero-oligosaccharides, nigerotriose, nigerotetraose, kojitriose, kojitetraose, dextrans, beta glucans, lichenan, isolichenan, and combinations thereof. In some embodiments the further soluble dietary fibre may comprises tapioca fibre and/or pea fibre.

The at least one fructan may be present in an amount of from 2-85 wt. % of the confectionery composition or 4-85, 6-85, 8-85, 10-85, 12-85, 14-85, 16-85, 18-85, 20-85, 22-85, 24-85, 26-85, 28-85, 30-85, 2-84, 2-82, 2-80, 2-78, 2-76, 2-74, 2-72, 2-70, 2-68, 2-66, 2-64, 2-62, 2-60, 2-58, 2-56, 2-54, 2-52, 2-50, 2-48, 2-46, 2-44, 2-42, 2-40, 2-38, 2-36, 2-35, 2-34, 2-32, 2-30, 2-28, 2-26, 2-24, 2-22, 2-20, 2-85, 4-84, 6-82, 8-80, 10-78, 10-76, 10-74, 10-72, 10-70, 10-68, 10-66, 10-64, 10-62, 10-60, 10-58, 10-56, 10-54, 10-52, 10-50, 10-48, 10-46, 10-44, 10-42, 10-40, 10-38, 10-36, 10-35, 12-35, 14-35, 16-35, 18-35, or 20-35 wt. % of the confectionery composition. Preferably, the at least one fructan may be present in an amount of 10-35 wt. % of the confectionery composition.

The at least one IMO may be present in an amount of from 2-60 wt. % of the confectionery composition or 4-72, 6-72, 8-72, 10-72, 12-72, 14-72, 16-72, 18-72, 20-72, 22-72, 24-72, 26-72, 28-72, 30-72, 2-70, 2-68, 2-66, 2-66, 2-64, 2-62, 2-60, 2-58, 2-56, 2-54, 2-52, 2-50, 2-48, 2-46, 2-44, 2-42, 2-40, 2-38, 2-36, 2-35, 2-34, 2-32, 2-30, 2-28, 2-26, 2-24, 2-22, 2-20, 2-72, 4-70, 6-68, 8-66, 10-64, 12-62, 14-60, 16-58, 18-56, 20-54, 22-52, 24-50, 25-48, 25-46, 25-44, 25-42, 25-40, 25-38, 25-36, 25-35, 26-35, 28-35, or 30-35 wt. % of the confectionery composition. Preferably, the IMO may be present in an amount of 20-45 wt. % or 25-35 wt. % of the confectionery composition.

The at least one further soluble dietary fibre may be present in an amount of from 2-72 wt. % of the confectionery composition or 4-72, 6-72, 8-72, 10-72, 12-72, 14-72, 16-72, 18-72, 20-72, 22-72, 24-72, 26-72, 28-72, 30-72, 2-70, 2-68, 2-66, 2-66, 2-64, 2-62, 2-60, 2-58, 2-56, 2-54, 2-52, 2-50, 2-48, 2-46, 2-45, 2-44, 2-42, 2-40, 2-38, 2-36, 2-35, 2-72, 4-70, 6-68, 8-66, 10-64, 10-62, 10-60, 10-58, 10-56, 10-54, 10-52, 10-50, 10-48, 10-46, 10-45, 12-45, 14-45, 16-45, 18-45, or 20-45 wt. % of the confectionery composition. Preferably, the at least one further soluble dietary fibre ingredients may be present in an amount of 10-45 wt. % of the confectionery composition.

The confectionery composition may comprise at least one fructan in an amount of from 2-85 wt. % of the confectionery composition; at least one isomaltose oligosaccharide in an amount of from 2-60 wt. % of the confectionery composition; and at least one further soluble dietary fibre ingredient in an amount of from 2-50 wt. % of the confectionery composition.

The confectionery composition may comprise at least one fructan in an amount of from 10-35 wt. % of the confectionery composition; at least one isomaltose oligosaccharide in an amount of from 25-35 wt. % of the confectionery composition; and at least one further soluble dietary fibre ingredient in an amount of from 10-45 wt. % of the confectionery composition.

The confectionery composition may be in the form of a caramel, fudge, nougat, marshmallow, jelly or honeycomb.

The confectionery composition may comprise less than 35, 30, 25, 20, 15, 10 or 5 wt. % sugar, or less than 4, 3, 2, 1 or 0.5 wt. % sugar. In some embodiments the confectionery composition may be essentially free from or free from sugar.

By “sugar” it is meant a monosaccharide or disaccharide with an energy content of >3 kcal/g. Examples of sugars included within the term are glucose, fructose, galactose, sucrose, lactose, maltose, isomaltose and sugar hydrates (such as dextrose monohydrate, for example), among others.

In some embodiments the confectionery composition may comprise less than 10, 5, 4, 3, 2, 1 or 0.5 wt. % sucrose, and comprise substantially no sucrose or no sucrose.

In some embodiments the confectionery composition may comprise less than 10, 5, 4, 3, 2, 1 or 0.5 wt. % glucose, and comprise substantially no glucose or no glucose.

The confectionery composition may comprise a sweetener. The sweetener may be an artificial sweetener and/or natural sweetener.

Artificial sweeteners may be selected from the group comprising: acesulfame K, advantame, alitame, aspartame, aspartame-acesulfame salt, cyclomates, glucin, neohespiridin dihydrochalcone, neotame, saccharin, sucralose, rebaudioside A, rebaudioside D, rebaudioside M and combinations thereof.

Natural sweeteners may be selected from the group comprising: glycyrrhizin, monatin, osladine, stevia, steviol glycosides, monk fruit, mogrosides, and combinations thereof.

The confectionery composition may comprise one or more further ingredients. The one or more further ingredients may be selected from the group consisting of egg powder, foaming agents, milk powder, hydrocolloids (such as pectin, carrageen, gum Arabic, xanthan, modify starch, resistant starch and/or gelatine), emulsifier, fat, oil, thickener, preservative, water, acids, pH buffers, colours and flavours, and combinations thereof.

The confectionery composition may comprise nougat, and may comprise in addition to the at least one fructan; at least one isomaltose oligosaccharide (IMO); and at least one further soluble dietary fibre; one or more ingredients selected from the group comprising: egg powder, egg albumin, foaming agents, hydrocolloids (such as pectin, carrageen, gum Arabic, xanthan, modify starch, resistant starch and/or gelatine), thickener, preservative, water, colours and flavours, and combinations thereof.

The confectionery composition may comprise fudge, and may comprise in addition to the at least one fructan; at least one isomaltose oligosaccharide (IMO); and at least one further soluble dietary fibre; one or more ingredients selected from the group comprising: fat, oil, emulsifiers, milk powders, thickener, preservative, water, colours and flavours, and combinations thereof.

The confectionery composition may comprise marshmallow, and may comprise in addition to the at least one fructan; at least one isomaltose oligosaccharide (IMO); and at least one further soluble dietary fibre; one or more ingredients selected from the group comprising: egg powder, egg albumin, foaming agents, hydrocolloids (such as pectin, carrageen, gum Arabic, xanthan, modify starch, resistant starch and/or gelatine), thickener, preservative, water, acid, colours and flavours, and combinations thereof.

The confectionery composition may comprise honeycomb, and may comprise in addition to the at least one fructan; at least one isomaltose oligosaccharide (IMO); and at least one further soluble dietary fibre; one or more ingredients selected from the group comprising: egg powder, egg albumin, foaming agents, hydrocolloids (such as pectin, carrageen, gum Arabic, xanthan, modify starch, resistant starch and/or gelatine), thickener, preservative, water, acid, colours and flavours, and combinations thereof.

The confectionery composition may comprise jelly confectionery, and may comprise in addition to the at least one fructan; at least one isomaltose oligosaccharide (IMO); and at least one further soluble dietary fibre; one or more ingredients selected from the group comprising: hydrocolloids (such as pectin, carrageen, gum Arabic, xanthan, modify starch, resistant starch and/or gelatine), thickener, preservative, water, acids, colours and flavours, and combinations thereof.

The confectionery composition may comprise caramel, and may comprise in addition to the at least one fructan; at least one isomaltose oligosaccharide (IMO); and at least one further soluble dietary fibre; one or more ingredients selected from the group comprising: fat, oil, emulsifiers, milk powders, thickener, preservative, water, colours and flavours, and combinations thereof.

The confectionery composition may comprise less than 10 wt. % sugar alcohols, or less than 9, 8, 7, 6, 5, 4, 3, 2, 1 or 0.5 wt. % sugar alcohols. In some embodiments the confectionery composition may be essentially free from or free from sugar alcohols.

Advantageously, the reduction of the amount of sugar alcohols in the confectionery filling reduces any potential laxative problems for the consumer.

By “sugar alcohol” it is meant a sugar alcohol with an energy of 0-4.5 kcal/g. Examples of sugar alcohols included within the term are erythritol, maltitol, mannitol, sorbitol, xylitol, arabitol, sorbitol, glycerol, hydrogenated starch hydrolysates (HSH), isomalt and lactitol.

The confectionery composition may comprise less than 5 wt. % low energy sugar, or less than 4, 3, 2, 1 or 0.5 wt. % low energy sugar. In some embodiments the confectionery composition may be essentially free from or free from low energy sugar.

By “low energy sugar” it is meant a sugar having an energy content of less than 2 kcal/g. Examples of low energy sugars included within the term are tagatose, sorbose, cellobiose, xylose, altrose, L-glucose and psicose.

In a second aspect of the present invention, there is provided a confectionery product comprising a confectionery composition according to the first aspect and at least one further confectionery material.

The confectionery composition may comprise a confectionery filling within a shell of the further confectionery product. In some embodiments the confectionery composition may comprise a layer in a layered product comprising at least one layer of confectionery composition and at least one layer of further confectionery material. The confectionery composition layer may be between two layers of further confectionery material. The confectionery composition may be a centre of a confectionery product

The confectionery product may be chocolate or a chocolate product.

In such an embodiment, the further confectionery material may be a chocolate shell.

The confectionery composition according to the first aspect may be partially or fully surrounded by a chocolate shell. An outer surface of the confectionery composition may be at least 50% surrounded by the chocolate shell, or at least 60, 70, 80, or at least 90%, or substantially 100% of the outer surface area of the confectionery composition may be surrounded by the chocolate shell. The chocolate shell may form a layer of even or uneven thickness. In some embodiments, the layer has a thickness of at least 1, 2, 3, 4, or at least 5 mm. The layer may have a thickness of no greater than 10, 9, 8, 7, 6, 5, 4, 3, 2 or 1 cm.

In one embodiment, the confectionery composition may be coated or enrobed with a chocolate shell. The chocolate shell may comprise a layer of coating material on a surface of the confectionery filling, preferably an outer surface. The chocolate shell may comprise a layer of coating material over at least 50% of the outer surface area of the confectionery filling, or over at least 60, 70, 80, 90%, or over substantially 100% of the outer surface area of the confectionery filling.

The term ‘chocolate’ includes any material that meets a legal definition of chocolate in any jurisdiction; however, the term ‘chocolate’ is not limited to material which meets any legal definition of chocolate and also includes chocolate substitutes and analogues. For instance, ‘chocolate’ herein includes materials in which all or part of the cocoa butter (CB) of legally or regulatory-defined chocolate is replaced by cocoa butter equivalents (CBE), cocoa butter substitutes (CBS), cocoa butter replacers (CBR) and/or other lipids. For example, the term “chocolate” also includes chocolates in which part, or all the cocoa butter has been replaced by vegetable fat. The term ‘compound chocolate’ as used herein means chocolate-like analogues characterized by presence of one or more cocoa solids from any part of the cocoa bean or cocoa pod (which may be one or more selected from the group consisting of cocoa mass, cocoa butter, cocoa powder, cocoa pulp, cocoa husk and cocoa shell,) in any amount.

The term ‘cocoa’, as used in any context throughout this specification, is also taken to include the tautologous terminology ‘cacao’.

The confectionery composition may comprise at least 75 wt. % of the product, or at least 76, 77, 78, 79 or 80 wt. % of the product. The confectionery filling may comprise up to 85 wt. % of the product, or up to 84, 83, 82, 81, 80 wt. % of the product. The chocolate shell may comprise 75-85 wt. % of the product, or 76-85, 77-85, 78-85, 79-85, 80-85, 75-84, 75-83, 75-82, 75-81, or 75-80 wt. % of the product.

The chocolate shell may comprise at least 16 wt. % of the product, or at least 17, 18, 19, or 20 wt. % of the product. The chocolate shell may comprise up to 25 wt. % of the product, or up to 24, 23, 22, 21, 20 wt. % of the product. The chocolate shell may comprise 15-25 wt. % of the product, or 16-25, 17-25, 18-25, 19-25, 20-25, 15-24, 15-23, 15-22, 15-21, or 15-20 wt. % of the product.

The chocolate product may comprise up to 35 wt. % total sugars, up to 34 wt. %, up to 33 wt. %, up to 32 wt. %, up to 31 wt. %, up to 30 wt. %, up to 29 wt. %, up to 28 wt. %, up to 27 wt. %, up to 26 wt. %, up to 25 wt. %, up to 24 wt. %, up to 22 wt. %, up to 20 wt. %.

The chocolate product may comprise at least 10 wt. % total sugars, suitably at least 12 wt. %, suitably at least 14 wt. %, suitably at least 16 wt. %, at least 18 wt. %, or at least 20 wt. % total sugars.

The chocolate product may comprise from 5 to 35 wt. % total sugars, from 6 to 35 wt. %, from 8 to 35 wt. %, from 10 to 35 wt. %, from 12 to 35 wt. %, from 14 to 35 wt. %, 15 to 35 wt. %, 15 to 30 wt. %, 15 to 25 wt. % total sugars.

It should be understood that some or all of the total sugars may be present in the chocolate shell, in order for the product to achieve total sugars of up to 35 wt. % of the chocolate product.

The chocolate shell may comprise at least 50% of the total sugars in the chocolate product, at least 60%, at least 70%, at least 80%, at least 85%, at least 90%. In some embodiments the chocolate shell may comprise no more than 99%, 98%, 97%, 96%, 95%, 94%, 93%, 92%, or 91% of the total sugars in the chocolate product.

The chocolate shell may comprise 50 to 100%, 60 to 100%, 70 to 100%, 80 to 100%, 80 to 95%, 85 to 95%, 80 to 90%, 80 to 85%, 85 to 90% of the total sugars in the chocolate product.

The total sugars or total sucrose and/or glucose of the chocolate product may be reduced by at least 10% compared to a known reference “full sugar” or sucrose-based and/or glucose-based chocolate product, suitably reduced by at least 15%, suitably at least 20%, suitably at least 25%, suitably at least 28% or at least 30%. In some embodiments the total sugars or total sucrose of the chocolate product may be reduced by at least 40%, for example at least 45%, at least 50%, at least 55%, at least 60%, at least 65%, or at least 70%. In some embodiments the total sugars of the chocolate product may be reduced by up to 755, up to 70%, up to 65%, up to 60%, up to 55%, up to 50% when compared to a known reference “full sugar” chocolate product. The total sugars may be reduced whilst retaining the taste and texture of a “full sugar” or sucrose-based and/or glucose-based chocolate product comprising a confectionery filling.

The chocolate shell may comprise up to 35 wt. % of cocoa ingredients, such as cocoa mass, cocoa butter, cocoa powder, cocoa pulp, cocoa husk and cocoa nib shell, suitably up to 32 wt. %, for example up to 30 wt. % of cocoa-ingredients. The chocolate shell may comprise from 15 to 35 wt. % of cocoa ingredients, suitably from 20 to 30 wt. %, for example from 25 to 30 wt. % of cocoa ingredients.

The chocolate product may comprise at least 1 wt. % of total fat, or at least 2 wt. %, or at least 3 wt. % of total fat. The chocolate product may comprise up to 20 wt. %, 15 wt. %, 10 wt. % or up to 5 wt. % of total fat, or up to 4 wt. %, or up to 3 wt. % of total fat.

The confectionery product may be a confectionery composition according to the first aspect coated or enrobed with a chocolate shell. The chocolate shell may comprise a layer of coating material on a surface of the confectionery composition, preferably an outer surface. The chocolate shell may comprise a layer of coating material over at least 50% of the outer surface area of the confectionery filling, or over at least 60, 70, 80, 90%, or over substantially 100% of the outer surface area of the confectionery filling.

In some embodiments, the chocolate shell may assume any shape, such as an egg, animal, star, Santa, lentil, bean, lozenge, cuboid, sphere etc.

The chocolate product may comprise a tablet or block of chocolate shell comprising the confectionery composition of the invention and may comprise multiple portions of chocolate shell and confectionery composition, connected via break lines or regions, for example.

The chocolate in the chocolate product may be a non-milk or low milk containing (commonly referred to as plain and/or dark), milk, compound, or white chocolate. Preferably, the chocolate is a plain, dark or milk chocolate.

The further confectionery material may be a non-chocolate confectionery material.

The further confectionery material may be a hard candy, jelly candy, chewy candy, toffee, fudge, marshmallow etc. In such an embodiment, the further confectionery material may be any material known to be present in a hard candy, jelly candy, chewy candy, toffee, fudge or marshmallow.

The confectionery product may be packaged in any suitable packaging material, which may in some embodiments be any one or more materials independently selected from the group comprising cardboard, paper, paperboard, flow-wrap plastics, metal foil, plastics foil and combinations and laminates thereof.

Suitable packaging for the confectionery product may be reclosable or not reclosable (or resealable or not resealable) as known to a person skilled in the art.

The confectionery product may be provided in a form and size intended for a single serving.

A single serving may have a weight in the range of from 10 g to 200 g.

In some embodiments the confectionery product may be provided in a form and size intended to provide multiple servings. The multiple serving of the confectionery product may have a weight greater than 30 g, 40 g, 50 g, 60 g, 70 g, 80 g, 90 g, 100 g, 250 g or greater than 500 g.

When the confectionery product is a chocolate product, the multiple serving of the chocolate product may comprise a single body. The single body of chocolate product may have defined portions intended to be broken or torn off the body of the chocolate product to provide a serving of the product. A suitable form of the one body of the chocolate product may be a tablet, block, or bar.

In some embodiments, a multiple serving of the chocolate product may be provided as individual pieces. Suitably, the bite-size pieces may have a weight in the range of from 1 g to 30 g. The bite-size pieces may be individually wrapped. Alternatively, the bite-size pieces may not be individually wrapped. A plurality of bite-size pieces may be contained in a suitable container. The container may be reclosable and/or resealable.

According to a third aspect of the present invention there is provided a composition comprising:
a) at least one fructan in an amount of 2 to 85 wt. % of the composition;
b) at least one isomaltose oligosaccharide in an amount of 2 to 60 wt. % of the composition; and
c) at least one further soluble dietary fibre ingredient in an amount of 2 to 50 wt. % of the composition.

Statements of invention relating to the confectionery composition of the first aspect of the invention may also be applied to the third aspect of the invention.

According to a fourth aspect of the present invention, there is provided a method of preparing the confectionery composition of the first aspect of the invention, the method comprising the step of combining at least one fructan, at least one isomaltose oligosaccharide, and at least one further soluble dietary fibre.

Any suitable method of combining the confectionery composition ingredients known to those skilled in the art may be employed.

According to a further aspect of the present invention, there is provided a method of preparing a confectionery product according to a second aspect of the present invention, the method comprising the steps of providing a confectionery composition of the first or third aspect of the invention as a filling and at least one further confectionery material and depositing the confectionery composition into the further confectionery material.

In an embodiment wherein the further confectionery material is a chocolate shell, the method may comprise the steps of providing a chocolate shell and providing a confectionery composition filling, depositing the confectionery composition filling into the chocolate shell and optionally sealing the chocolate shell.

Chocolate shells of any suitable shape may be provided, such as eggs, animals, stars, Santa, etc.

In some embodiments, the chocolate shell is provided as two complementary fitting sections. The complementary fitting sections of the shell may be attachable to each other to provide a sealed chocolate shell defining an internal cavity capable of containing the filling. At least one or both complementary fitting sections of the shell may define their own cavity into which the filling may be independently deposited before attaching the sections to each other to provide the sealed chocolate shell. The filling in each section may be the same or different. In some embodiments, only one of the two complementary fitting sections of the shell defines its own cavity, and the other section is in the form of a flat or substantially flat chocolate backing.

In some embodiments, the step of providing the chocolate shell comprises forming a first section of the shell in a mould cavity. In such embodiments, the first section defines a cavity in the shape of the mould cavity and into which the filling may be deposited. Moulds may preferably be selected to match the shapes and/or sizes of the chocolate product as detailed in the first aspect of the invention. The step of sealing the chocolate shell may comprise applying a chocolate backing over the first section of the shell and over the filling contained in the first section to seal the shell with the filling enclosed within.

The step of sealing the chocolate shell by attaching two complementary fitting sections of the shell to each other may employ any suitable method known to those skilled in the art. Examples of suitable methods include but are not limited to gluing the sections to each other using an edible glue or applying heat to the points of contact of the two sections to facilitate sealing.

Alternatively, the method may comprise the steps of providing a confectionery composition of the invention and at least one further confectionery material and coating the confectionery composition with the confectionery material.

In one embodiment wherein the confectionery material is a chocolate shell, the method may comprise the steps of providing a chocolate shell and providing a confectionery filling comprising the confectionery composition of the invention, and coating the confectionery filling with the chocolate shell.

Any suitable method of coating known to those skilled in the art may be employed. Such a method may provide a layer of the chocolate shell on a surface of the confectionery filling. The surface may comprise an outer surface of the confectionery filling. The method may comprise coating a layer of the chocolate shell on at least 50% of the outer surface area of the confectionery filling, or on at least 60, 70, 80, 90%, or on substantially 100% of the outer surface area of the confectionery filling.

In some embodiments, the step of coating may comprise enrobing the confectionery filling with the chocolate shell. The method may comprise passing the confectionery filling through a curtain or stream of the chocolate shell. The curtain or stream may be formed by a molten chocolate shell falling from an elevated position relative to the edible product. The molten chocolate shell may fall from an elevated trough or like device fed from a suitable container.

In some embodiments, the step of coating may comprise dipping the confectionery filling into a chocolate shell. Suitable methods of dipping include hand-dipping and dipping the edible product using suitable machinery known in the art.

In some embodiments, the step of coating may comprise pan coating the confectionery filling with the chocolate shell. Pan coating is known to those skilled in the art and makes use of rotating drums to coat the confectionery filling with a chocolate shell coating. The pan coating method may include but is not limited to one or more of: spray pan coating, ladling, and drip-feeding.

The method may further comprise a step of moulding or extruding the chocolate product to form a bar or block, after filling the chocolate shell. Preferably, the method may comprise moulding the chocolate product to form a solid bar or block.

The method may include any one or more of size-reducing, refining, conching, tempering and pasting the chocolate product, or ingredients thereof, as is customary in the art of chocolate-making.

The method may further comprise packaging the confectionery product to produce a packaged confectionery product.

According to another aspect of the invention there is provided a method of providing a filled or coated food product, in which a food product is filled or coated with a confectionery product of the second aspect of the invention.

In some embodiments, the inventive confectionery product of the second aspect of the invention is applied to a food product as a coating. In some embodiments, the confectionery product is applied as a molten coating and solidified. The food product may be a chocolate product or non-chocolate product. Food products include but are not limited to those listed for the second aspect of the invention.

Any suitable method of coating known to those skilled in the art may be employed. Such a method may provide a layer of the inventive confectionery product on a surface of the food product. The surface may comprise an outer surface of the food product. The method may comprise coating a layer of the inventive confectionery product on at least 50% of the outer surface area of the food product, or on at least 60, 70, 80, 90%, or on substantially 100% of the outer surface area of the food product.

In some embodiments, the method comprises enrobing the food product with the inventive confectionery product. The method may comprise passing the food product through a curtain or stream of the inventive confectionery product. The curtain or stream may be formed by molten inventive confectionery product falling from an elevated position relative to the food product. The molten inventive confectionery product may fall from an elevated trough or like device fed from a suitable container.

In some embodiments, the method comprises dipping the food product into the molten inventive confectionery product. Suitable methods of dipping include hand-dipping and dipping the food product using suitable machinery known in the art.

In some embodiments, the method comprises pan coating the food product with the inventive confectionery product. Pan coating is known to those skilled in the art and makes use of rotating drums to coat the food product with a chocolate coating. The pan coating method may include but is not limited to one or more of: spray pan coating, ladling, and drip-feeding.

In some embodiments, the method comprises filling a food product with the prepared inventive confectionery product. Any suitable method of filling known to those skilled in the art may be employed. The food product may include but is not limited to the food products described in the second aspect of the invention, especially confectionery and farinaceous or baked products. The food product may be provided in the form of one or more shells, as described hereinabove for embodiments in which the confectionery product is provided as one or more shells. In some embodiments, the confectionery product, in molten or paste form, may be extruded, injected, or otherwise deposited into a cavity formed in the food product, and optionally solidified thereafter.

The filled or coated food product may be packaged, as described hereinabove for other aspects of the invention.

The method may further comprise packaging the confectionery product to produce a packaged confectionery product.

The further aspects of the present invention may incorporate any of the features of the other aspects of the invention described herein as desired or as appropriate.

### DETAILED DESCRIPTION OF THE INVENTION

In order that the invention may be more clearly understood one or more embodiments thereof will now be described, by way of example only:

### Inventive Confectionery Compositions

The following confectionery compositions of the invention were prepared.

The confectionery compositions of the invention were prepared as fillings, and the filling ingredients were combined using standard techniques.

The confectionery filing compositions were relatively low in saturated fat, sugar (zero sucrose), and energy (calories), whilst still providing equivalent manufacturing qualities, texture and function as standard “full sugar” or sucrose-based and/or glucose-based confectionery compositions.

### EXAMPLE 1

### Caramel Confectionery Composition

The ingredients for the caramel confectionery composition are detailed in Table 1 below.

TABLE 1

| | Wet | |
|---|---|---|
| | Weight | % soluble |
| | % of | dietary |
| | ingredient | fibre of |
| Ingredient | in filling | ingredient |
| Water | 6.1 | — |
| canola oil | 4 | — |
| soya lecithin | 0.03 | — |
| Inulin (Orafti ® HIS/Orafti ® L90/Fructulose) | 14.7 | 85-90 |
| IMO (DP3 VitafiberTM/IMO VitafiberTM/IMO | 38 | 60-90 |
| HDP Oligosmart ®/IMO OligoSmart ®) | | |
| Soluble fibre - liquid corn; (PROMITOR ® | 21 | 70-95 |
| 85NL, Tate & Lyle/Promitor ® L70/Promitor ® | | |
| 85/Nutriose ® 06/Nutriose ® 10) | | |
| Soluble Tapioca fibre syrup (FiberSMART ® | 21 | 65-80 |
| syrup/Promitor ® L70/Promitor ® 85/ | | |
| Nutriose ® 06/Nutriose ® 10) | | |
| Skim milk powder | 7 | — |
| Sodium chloride | 0.2 | — |
| Vanilla flavour | 0.2 | — |

The confectionery filling only comprised a minimal amount of sugar in the form of lactose in the milk powder, and monosaccharides in the fibre ingredient compositions and no sucrose at all was present in the composition.

The confectionery composition was able to provide an equivalent texture and function as a sucrose-based and/or glucose-based confectionery filling.

### EXAMPLE 2

### Jelly Confectionery Composition

The ingredients for the jelly confectionery filling are detailed in Table 2 below.

TABLE 2

| | Wet | |
|---|---|---|
| | Weight | % soluble |
| | % of | dietary |
| | ingredient | fibre of |
| Ingredient | in filling | ingredient |
| Water | 11.1 | — |
| Inulin (Orafti ® HIS/Orafti ® L90/Fructulose) | 13 | 85-90 |
| IMO (DP3 VitafiberTM/IMO VitafiberTM/IMO | 35 | 60-90 |
| HDP Oligosmart ®/IMO OligoSmart ®) | | |
| Soluble Tapioca fibre syrup (FiberSMART ® | 40 | 85-90 |
| syrup/Promitor ® L70/Promitor ® 85/Nutriose ® | | |
| 06/Nutriose ® 10) | | |
| Polydextrose (Sta-lite ® L90) | 15 | 70-90 |
| Unipectine ™ PG 759 | 1.5 | — |
| Thin boiling starch | 5 | — |
| Citric acid (50% solution) | 1.1 | — |
| Trisodium citrate | 0.22 | — |
| Red colour solution | 0.35 | — |
| Strawberry flavour | 0.15 | — |

The confectionery filling only comprised a minimal amount of sugar in the form monosaccharides in the fibre ingredient compositions and no sucrose at all was present in the composition.

The confectionery composition was able to provide an equivalent texture and function as a sucrose-based and/or glucose-based confectionery filling.

### EXAMPLE 3

### Nougat Confectionery Composition

The ingredients for the nougat confectionery filling are detailed in Table 3 below.

TABLE 3

| | Wet | |
|---|---|---|
| | Weight | % insoluble |
| | % of | dietary |
| | ingredient | fibre of |
| Ingredient | in filling | ingredient |
| Water | 2.6 | — |
| Inulin (Orafti ® HIS/Orafti ® L90/Fructulose) | 35 | 85-90 |
| IMO (DP3 VitafiberTM/IMO VitafiberTM/ | 42 | 60-90 |
| IMO HDP Oligosmart ®/IMO OligoSmart ®) | | |
| Soluble Tapioca fibre syrup (FiberSMART ® | 17 | 65-80 |
| syrup/Promitor ® L70/Promitor ® 85/ | | |
| Nutriose ® 06/Nutriose ® 10) | | |
| egg albumin | 2 | — |
| Unipectine ™ PG 759 | 1.4 | — |

The confectionery filling only comprised a minimal amount of sugar in the form of monosaccharides in the fibre ingredient compositions and no sucrose at all was present in the composition.

The confectionery composition was able to provide an equivalent texture and function as a sucrose-based and/or glucose-based confectionery filling.

### EXAMPLE 4

### Marshmallow Confectionery Composition

The ingredients for the marshmallow confectionery filling are detailed in Table 4 below.

TABLE 4

| | Wet | |
|---|---|---|
| | Weight | % insoluble |
| | % of | dietary |
| | ingredient | fibre of |
| Ingredient | in filling | ingredient |
| Water | 2.6 | — |
| Inulin (Orafti ® HIS/Orafti ® L90/Fructulose) | 35 | 85-90 |
| IMO (DP3 VitafiberTM/IMO VitafiberTM/ | 42 | 60-90 |
| IMO HDP Oligosmart ®/IMO OligoSmart ®) | | |
| Soluble Tapioca fibre syrup (FiberSMART ® | 17 | 65-80 |
| syrup/Promitor ® L70/Promitor ® 85/ | | |
| Nutriose ® 06/Nutriose ® 10) | | |
| egg albumin | 2 | — |
| Unipectine ™ PG 759 | 1.4 | — |

The confectionery filling only comprised a minimal amount of sugar in the form of monosaccharides in the fibre ingredient compositions and no sucrose at all was present in the composition.

The confectionery composition was able to provide an equivalent texture and function as a sucrose-based and/or glucose-based confectionery filling.

### EXAMPLE 5

### Fudge Confectionery Composition

The ingredients for the fudge confectionery composition are detailed in Table 5 below.

TABLE 5

| | Wet | |
|---|---|---|
| | Weight | % insoluble |
| | % of | dietary |
| | ingredient | fibre of |
| Ingredient | in filling | ingredient |
| Water | −6.1 | — |
| canola oil | 4 | — |
| soya lecithin | 0.03 | — |
| Inulin (Orafti ® HIS/Orafti ® L90/Fructulose) | 14.7 | 85-90 |
| IMO (DP3 VitafiberTM/IMO VitafiberTM/ | 38 | 60-90 |
| IMO HDP Oligosmart ®/IMO OligoSmart ®) | | |
| Soluble fibre - liquid corn (PROMITOR ® | 21 | 80-95 |
| 85NL, Tate & Lyle/Promitor ® L70/ | | |
| Promitor ® 85/Nutriose ® 06/Nutriose ® 10) | | |
| Soluble Tapioca fibre syrup (FiberSMART ® | 21 | 65-80 |
| syrup/Promitor ® L70/Promitor ® 85/ | | |
| Nutriose ® 06/Nutriose ® 10) | | |
| Skim milk powder | 7 | — |
| Sodium chloride | 0.2 | — |
| Caramel flavour | 0.2 | — |

The confectionery filling only comprised a minimal amount of sugar in the form of lactose in the milk powder, and monosaccharides in the fibre ingredient compositions and no sucrose at all was present in the composition.

The confectionery composition was able to provide an equivalent texture and function as a sucrose-based and/or glucose-based confectionery filling.

### EXAMPLE 6

### Honeycomb Confectionery Composition

The ingredients for the honeycomb confectionery composition are detailed in Table 6 below.

TABLE 6

| | Wet | |
|---|---|---|
| | Weight | % insoluble |
| | % of | dietary |
| | ingredient | fibre of |
| Ingredient | in filling | ingredient |
| Water | −6.1 | — |
| canola oil | 4 | — |
| soya lecithin | 0.03 | — |
| Inulin (Orafti ® HIS/Orafti ® L90/Fructulose) | 14.7 | 85-90 |
| IMO (DP3 VitafiberTM/IMO VitafiberTM/ | 38 | 60-90 |
| IMO HDP Oligosmart ®/IMO OligoSmart ®) | | |
| Soluble fibre - liquid corn (PROMITOR ® | 21 | 80-95 |
| 85NL, Tate & Lyle/Promitor ® L70/ | | |
| Promitor ® 85/Nutriose ® 06/Nutriose ® 10) | | |
| Soluble Tapioca fibre syrup (FiberSMART ®) | 21 | 65-80 |
| syrup/Promitor ® L70/Promitor ® 85/ | | |
| Nutriose ® 06/Nutriose ® 10) | | |
| Skim milk powder | 7 | — |
| Sodium chloride | 0 | — |
| Caramel flavour | 0.2 | — |
| bicarbonate of soda/potassium carbonate | 1.8 | — |

The confectionery filling only comprised a minimal amount of sugar in the form of lactose in the milk powder, and monosaccharides in the fibre ingredient compositions and no sucrose at all was present in the composition.

The confectionery composition was able to provide an equivalent texture and function as a sucrose-based and/or glucose-based confectionery filling.

### Inventive Confectionery Products

The confectionery compositions of Examples 1-6 were used to prepare a chocolate confectionery product of the invention.

The confectionery compositions of Examples 1-6 were enrobed in a chocolate confectionery material. The chocolate was melted and tempered, and the confectionery compositions of Examples 1-6 where then fed through a chocolate curtain to produce an enrobed chocolate product comprising a confectionery composition centre of Examples 1-6.

The confectionery filing compositions were able to provide chocolate and confectionery products that were low in saturated fat, sugar, and energy (calories). The resulting products had a similar taste and mouthfeel profile to a chocolate product comprising a sucrose-based and/or glucose-based confectionery filling. Moreover, the products provided an authentic flavour, good mouthfeel, and good rigidity.

Moreover, the confectionery composition was able to reduce the amount of sugars and calories in the overall product whilst still providing equivalent manufacturing qualities, texture and function as standard “full sugar” or sucrose-based and/or glucose-based chocolate product.

The above embodiments are described by way of example only. Many variations are possible without departing from the scope of the invention as defined in the appended claims.

1. A confectionery composition comprising:
a) at least one fructan;
b) at least one isomaltose oligosaccharide (IMO); and
c) at least one further soluble dietary fibre ingredient.

2. A confectionery composition according to claim 1, wherein the at least one fructan is selected from the group consisting of inulin, fructooligosaccharide (FOS), levan, phlein, graminin, neo-levan, neo-inulin and combinations thereof.

3. A confectionery according to claim 1 or 2, wherein the at least one further soluble dietary fibre ingredient is selected from the group consisting of polydextrose, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, milk oligosaccharides, 2′-fucosyl lactose, lacto-n-neotetraose, glucan (i.e., glucose containing) oligosaccharides, cello-oligosaccharides (or cellodextrins), resistant dextrins (e.g., soluble corn fiber, soluble wheat fiber, soluble tapioca fiber, soluble pea fibre), nigero-oligosaccharides, nigerotriose, nigerotetraose, kojitriose, kojitetraose, dextrans, beta glucans, lichenan, isolichenan, and combinations thereof.

4. A confectionery composition according to claim 1, wherein the at least one fructan is present in an amount of from 2-85 wt. %, preferably 10-35 wt. % of the confectionery composition.

5. A confectionery composition according to claim 1, wherein the at least one IMO may be present in an amount of from 2-60 wt. %, preferably 25-35 wt. %, preferably 10-45 wt. % of the confectionery composition.

6. A confectionery composition according to claim 1, wherein the at least one further soluble dietary fibre ingredient may be present in an amount of from 2-72 wt. %, preferably 10-45 wt. % of the confectionery composition.

7. A confectionery composition according to claim 1, wherein the composition comprises at least one fructan in an amount of from 2-85 wt. % of the confectionery composition; at least one IMO in an amount of from 2-60 wt. % of the confectionery composition; and at least one further soluble dietary fibre ingredient in an amount of from 2-50 wt. % of the confectionery composition.

8. A confectionery composition according to claim 7, wherein the composition comprises at least one fructan in an amount of from 10-35 wt. % of the confectionery composition; at least one IMO in an amount of from 20-45 wt. % of the confectionery composition; and at least one further soluble dietary fibre ingredient in an amount of from 10-45 wt. % of the confectionery composition.

9. A confectionery composition according to claim 1, wherein the confectionery composition is a caramel, fudge, nougat, marshmallow, jelly or honeycomb.

10. A confectionery composition according to claim 1, wherein the composition comprises less than 35 wt. % sugars, or less than 30, 29, 28, 27, 26, 25, 20, 15, 10, 5, 4, 3, 2, 1 or 0.5 wt. % sugars.

11. A confectionery composition according to claim 1, wherein the filling composition is essentially free from sucrose or is free from sucrose.

12. A confectionery composition according to claim 1, wherein the composition comprises less than 10 wt. % sugar alcohols, or less than 5, 4, 3, 2, 1 or 0.5 wt. % sugar alcohols.

13. A confectionery composition according to claim 1, wherein the filling composition is essentially free from sugar alcohols.

14. A confectionery composition according to claim 1, wherein the composition is essentially free from a low energy sugar.

15. A confectionery product comprising a confectionery composition according to claim 1 and at least one further confectionery material.

16. A confectionery product according to claim 15, wherein the further confectionery material is a chocolate shell.

17. A confectionery product as claimed in claim 15 wherein the further confectionery material and confectionery composition are present as separate layers.

18. A method of preparing a confectionery composition according to claim 1, wherein the method comprises the step of combining at least one fructan, at least one isomaltose oligosaccharide, and at least one further soluble dietary fibre ingredient.

19. A method of preparing a confectionery product according to claim 15, wherein the method comprises the steps of providing a confectionery composition and at least one further confectionery material and depositing the confectionery composition into the further confectionery material.

20. A method of preparing a confectionery product according to claim 15, wherein the method comprises the steps of providing a confectionery composition and at least one further confectionery material, and coating the confectionery composition with the confectionery material.

21. A method of providing a filled or coated food product, wherein the method comprises the steps of filling or coating a confectionery product according to claim 15.

22. A packaged confectionery product according to claim 15.
